(19) United States
(12) Patent Application Publication
(10) Pub. No.: US 2015/0367286 A1
(43) Pub. Date: Dec. 24, 2015

(54) ETCHING LIQUID STORAGE APPARATUS AND A WET ETCHING DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventors: Liangliang Li, Beijing (CN); Zongjie Guo, Beijing (CN); Xiangqian Ding, Beijing (CN); Yao Liu, Beijing (CN); Jinchao Bai, Beijing (CN)

(21) Appl. No.: 14/521,400

(22) Filed: Oct. 22, 2014

(30) Foreign Application Priority Data
Jun. 18, 2014 (CN) 201410273131.7

(51) Int. Cl. B01D 61/42; C23F 1/08

(52) U.S. Cl. CPC B01D 61/422; C23F 1/08

(57) ABSTRACT

The embodiments of the present disclosure provide an etching liquid storage apparatus and a wet etching device, which relates to the field of display technology, and can reduce the concentration of foreign ions in the etching liquid, so as to avoid frequent replacement of the etching liquid, thereby ensuring stability of the etching process, meanwhile, can also prolong the service life of the etching liquid, so as to reduce the cost; the etching liquid storage apparatus comprises an etching liquid storage tank, an ion exchange membrane for enabling selective permeation of ions in the etching liquid, and an anode or a cathode located at both sides of the ion exchange membrane; wherein a first chamber is formed between the ion exchange membrane and the anode, a second chamber is formed between the ion exchange membrane and the cathode; it is used for manufacture of the wet etching device.

### FIELD OF THE DISCLOSURE

The present disclosure relates to the field of display technology, particularly to an etching liquid storage apparatus and a wet etching device.

### BACKGROUND OF THE DISCLOSURE

At present, the wet etching device is mainly used for etching metals and metal oxides such as indium tin oxide (ITO) or indium gallium zinc oxide (IGZO) etc.

In actual production, along with the etching process, the concentration of the metal ions in the etching liquid becomes higher and higher, which may results in bad influence to the etching reaction and change of the etching rate. If the concentration of the metal ions is too high, the performance of the wet etched product cannot meet the requirements, it will be necessary to replace the etching liquid timely.

On the basis of this, if the replacement frequency of the etching liquid is too high, the production cost will be increased; after the etching liquid is replaced, it needs to be heated again, which may consume certain energy, thus it may also result in increase of the production cost. In addition, the components of the etching liquid before and after the replacement change greatly, thus the etching rate, the parameters such as the key size and the gradient angle of the etching product may be changed possibly, thereby influencing stability of the etching process.

### SUMMARY OF THE DISCLOSURE

The embodiments of the present disclosure provide an etching liquid storage apparatus and a wet etching device, which can reduce the concentration of foreign ions in the etching liquid, and avoid frequent replacement of the etching liquid, thereby ensuring stability of the etching process, meanwhile can also prolong the service life of the etching liquid, so as to reduce the cost.

In order to achieve the above purposes, the embodiments of the present disclosure adopt the following technical solutions:

On the one hand, an etching liquid storage apparatus is provided, the etching liquid storage apparatus comprises an etching liquid storage tank, an ion exchange membrane for enabling selective permeation of ions in the etching liquid, and an anode or a cathode located at both sides of the ion exchange membrane; wherein a first chamber is formed between the ion exchange membrane and the anode, a second chamber is formed between the ion exchange membrane and the cathode.

Alternatively, the ion exchange membrane is a cation exchange membrane; wherein metal ions in the etching liquid enter the second chamber from the first chamber through the cation exchange membrane under the effect of electric field between the anode and the cathode.

Alternatively further, both the anode and the cathode adopt an inert electrode in the event that the metal ions are active metals; the anode adopts an inert electrode and the cathode adopts an electrode of the same material as the metal ions in the event that the metal ions are non-active metals.

Further, the inert electrode comprises a carbon electrode.

Alternatively, the cation exchange membrane, the anode and the cathode are all arranged at the interior of the etching liquid storage tank; a liquid inlet and a liquid outlet are further arranged on the etching liquid storage tank; wherein the liquid inlet is arranged at the top of the second chamber, the liquid outlet is arranged at the bottom of the second chamber.

Alternatively further, the volume of the first chamber is larger than the volume of the second chamber.

Alternatively, the etching liquid storage apparatus further comprises an electrodialysis means located at the exterior of the etching liquid storage tank; the cation exchange membrane, the anode and the cathode are all arranged at the interior of the electrodialysis means; wherein the top and the bottom of the first chamber are fed through with the top and the bottom of the etching liquid storage tank respectively.

Alternatively further, the etching liquid storage apparatus further comprises a waste liquid tank located at the exterior of the electrodialysis means; wherein the bottom of the second chamber is fed through with the waste liquid tank.

Alternatively, the anode and the cathode adopt a stick electrode; or the anode and the cathode adopt a planar electrode.

Alternatively, the anode is connected with the positive of a DC power supply, the cathode is connected with the negative of the DC power supply; wherein the power of the DC power supply is adjustable.

Preferably, the etching liquid storage apparatus further comprises a concentration manager connected with the etching liquid storage tank for performing real time monitoring of concentrations of respective components of the etching liquid.

On the other hand, a wet etching device is provided, the wet etching device comprises an etching liquid storage apparatus stated above.

The embodiments of the present disclosure provide an etching liquid storage apparatus and a wet etching device, the etching liquid storage apparatus comprises an etching liquid storage tank, an ion exchange membrane for enabling selective permeation of ions in the etching liquid, and an anode or a cathode located at both sides of the ion exchange membrane; wherein a first chamber is formed between the ion exchange membrane and the anode, a second chamber is formed between the ion exchange membrane and the cathode.

Based on this, under the effect of electric field between the anode and the cathode, the cations in the etching liquid tend to move towards the cathode, the anions in the etching liquid tend to move towards the anode; on the basis of this, the ion exchange membrane located between the anode and the cathode has permselectivity to the ions in the etching liquid, thus it would cause the content of the cations in the second chamber and/or the content of the anions in the first chamber to be higher and higher. In this way, by gathering the cations and anions in the etching liquid in different regions, it only needs to replace the etching liquid in some regions when replacing the etching liquid; for example, when it is required to reduce the concentration of the cations, only the etching liquid in the second chamber needs to be replaced, when it is required to reduce the concentration of the anions, only the etching liquid in the first chamber needs to be replaced. It can be seen from this that by introducing an ion exchange system consisting of the ion exchange membrane, the anode and the cathode in the etching liquid storage apparatus, not only the concentration of the foreign ions in the etching liquid can be reduced effectively, so as to avoid frequent replacement of the etching liquid, thereby ensuring stability of the etching process, but also the service life of the etching liquid can be prolonged so as to reduce the cost.

### BRIEF DESCRIPTION OF DRAWINGS

In order to explain the technical solutions in the embodiments of the present disclosure or in the prior art more clearly, the drawings to be used in the depictions of the embodiments or the prior art will be introduced briefly in the following, apparently, the drawings described below are only some of the embodiments of the present disclosure, the ordinary skilled person in the art can also obtain other drawings based on these drawings without paying any creative work.

FIG. 1 is a structural schematic view I of an etching liquid storage apparatus provided by an embodiment of the present disclosure;

FIG. 2 is a structural schematic view II of an etching liquid storage apparatus provided by an embodiment of the present disclosure.

### REFERENCE SIGNS

101—ion exchange membrane/cation exchange membrane; 102—anode; 103—cathode; 10a—first chamber; 10b—second chamber; 20—etching liquid storage tank; 201—liquid inlet; 202—liquid outlet; 30—electrodialysis means; 40—waste liquid tank.

### DETAILED DESCRIPTION OF THE DISCLOSURE

The technical solutions in the embodiments of the present disclosure will be described clearly and completely in combination with the drawings in the embodiments of the present disclosure in the following, apparently, the embodiments described are only part rather than all of the embodiments of the present disclosure. Based on the embodiments in the present disclosure, all the other embodiments obtained by the ordinary skilled person in the art without paying any creative work belong to the protection scope of the present disclosure.

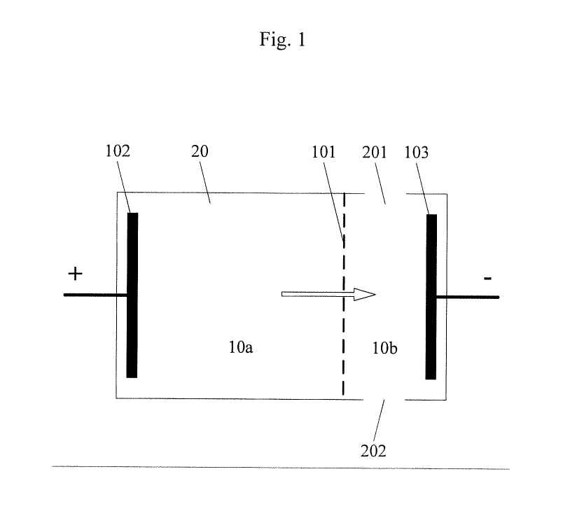

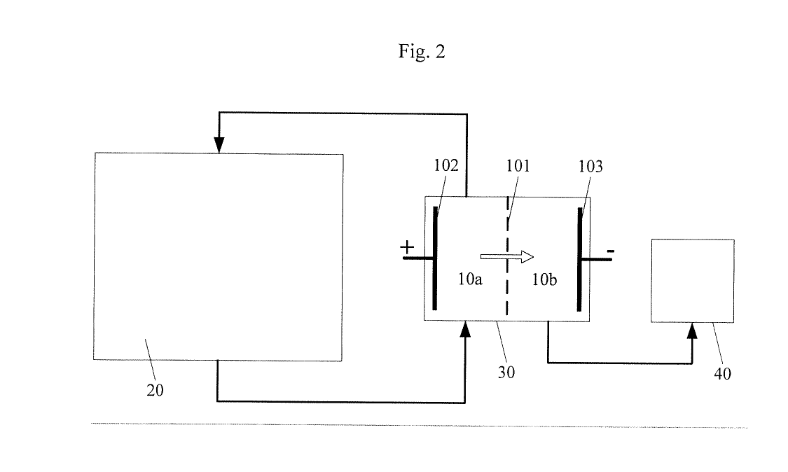

An embodiment of the present disclosure provides an etching liquid storage apparatus, as shown in FIG. 1 and FIG. 2, the etching liquid storage apparatus may comprise an etching liquid storage tank 20, an ion exchange membrane 101 for enabling selective permeation of ions in the etching liquid, and an anode 102 or a cathode 103 located at both sides of the ion exchange membrane 101; wherein a first chamber 10a is formed between the ion exchange membrane 101 and the anode 102, a second chamber 10b is formed between the ion exchange membrane 101 and the cathode 103.

It should be explained that firstly, the etching liquid storage tank 20 is mainly used for storing the etching liquid, hence, its interior surface can use materials with good corrosion resistance so as to avoid from being corroded by the etching liquid.

Secondly, the embodiment of the present disclosure introduces an ion exchange system consisting of the ion exchange membrane 101, the anode 102 and the cathode 103 in the etching liquid storage apparatus, and perform selective permeation to the ions in the etching liquid through electrodialysis effect of the ion exchange membrane 101.

Wherein the anode 102 and the cathode 103 are mainly used for providing an electric field for the ion exchange system, the specific shapes of the anode 102 and the cathode 103 are not defined here, as long as a directional electric field can be formed between the electrodes.

The ion exchange membrane 101 may be an anion exchange membrane for permeating anions in the etching liquid; or the ion exchange membrane 101 may also be a cation exchange membrane for permeating cations in etching liquid; or the ion exchange membrane 101 may also 20 be an amphoteric exchange membrane for performing selective permeation to the anions and the cations simultaneously. The type of the ion exchange member is not defined specifically here, it is selected based on the actual production requirement.

Thirdly, the etching liquid storage apparatus can introduce an ion exchange system consisting of the ion exchange membrane 101, the anode 102 and the cathode 103 in the etching liquid storage tank 20 directly, and can also arrange the ion exchange system consisting of the ion exchange membrane 101, the anode 102 and the cathode 103 at the exterior of the etching liquid storage tank 20 independently, so as to realize selective permeation of the ions in the etching liquid. The embodiment of the present disclosure does not define the specific setting manners of the ion exchange membrane 101, the anode 102 and the cathode 103.

An embodiment of the present disclosure provides an etching liquid storage apparatus, the etching liquid storage apparatus may comprise an etching liquid storage tank 20, an ion exchange membrane 101 for enabling selective permeation of ions in the etching liquid, and an anode 102 or a cathode 103 located at both sides of the ion exchange membrane 101; wherein a first chamber 10a is formed between the ion exchange membrane 101 and the anode 102, a second chamber 10b is formed between the ion exchange membrane 101 and the cathode 103.

Based on this, under the effect of electric field between the anode 102 and the cathode 103, the cations in the etching liquid tend to move towards the cathode 103, the anions in the etching liquid tend to move towards the anode 102; on the basis of this, the ion exchange membrane 101 located between the anode 102 and the cathode 103 has permselectivity to the ions in the etching liquid, thus it would cause the content of the cations in the second chamber 10b and/or the content of the anions in the first chamber 10a to be higher and higher. In this way, by gathering the cations and anions in the etching liquid in different regions, it only needs to replace the etching liquid in some regions when replacing the etching liquid; for example, when it is required to reduce the concentration of the cations, only the etching liquid in the second chamber 10b needs to be replaced, when it is required to reduce the concentration of the anions, only the etching liquid in the first chamber 10a needs to be replaced. It can be seen from this that by introducing an ion exchange system consisting of the ion exchange membrane 101, the anode 102 and the cathode 103 in the etching liquid storage apparatus, not only the concentration of the foreign ions in the etching liquid can be reduced effectively, so as to avoid frequent replacement of the etching liquid, thereby ensuring stability of the etching process, but also the service life of the etching liquid can be prolonged so as to reduce the cost.

In the wet etching process, the etching liquid needs to be extracted from the etching liquid storage tank 20 into the etching reaction chamber, so as to realize etching of the substance to be etched; subsequently, it is retrieved into the etching liquid storage tank 20 so as to realize recycling of the etching liquid.

Thus it can be seen that the etching liquid will be retrieved into the etching liquid storage tank 20 after the etching reaction, then the component and the concentration of the etching liquid will inevitably be changed correspondingly. When the component and the concentration of the etching liquid are changed to some extent, it will be required to replace the etching liquid.

Based on this, alternatively, the etching liquid storage apparatus may further comprise a concentration manager (not shown in the figure) connected with the etching liquid storage tank 20 for performing real time monitoring of concentrations of respective components of the etching liquid.

In this way, by performing real time monitoring of the concentrations of respective components of the etching liquid through the concentration manager, the concentration change conditions of respective components in the etching liquid will be found timely so as to control the time of replacing the etching liquid accurately.

It should be explained that the replacement of the etching liquid here may specifically be replacement of part of the etching liquid, and may also be replacement of all the etching liquid certainly. However, based on the purpose of the present disclosure, it is preferred here to replace part of the etching liquid.

Considering that the wet etching process is mainly used for etching metals and metal oxides such as ITO or IGZO, and many metal ions exist in the etching liquid after the etching reaction, in order to ensure stability of the wet etching process, it is required to discharge the metal ions in the etching liquid timely.

On the basis of this, the ion exchange membrane 101 is preferably a cation exchange membrane; wherein the metal ions in the etching liquid can enter the second chamber 10b from the first chamber 10a through the cation exchange membrane 101 under the effect of electric field between the anode 102 and the cathode 103.

Specifically, the cation exchange membrane 101 has permselectivity, it can permit the cations with positive charges to pass through only, while making the anions with negative charges not to pass through. On the basis of this, under the effect of electric field between the anode 102 and the cathode 103, the cations (specifically metal ions) in the etching liquid will move towards the direction of the cathode 103, such that the metal ions in the first chamber 10a originally will enter the second chamber 10b through the cation exchange membrane 101, while the metal ions in the second chamber 10b originally are still in said chamber under the effect of electric field. In this way, the metal ions in the etching liquid will be gathered in the second chamber 10b gradually, when it is enriched to some extent, this part of etching liquid will be able to be replaced, thereby ensuring relative stability of the components of the etching liquid and saving cost simultaneously.

It should be explained here that since the cation exchange membrane 101 has permeation function to the cations only, while having blocking function to the anions, under the effect of electric field, even if the anions are inclined to move towards the anode 102, the anions in the second chamber 10b will not be able to enter the first chamber 10a due to the blocking function of the cation exchange membrane 101, the anions in the first chamber 10a are still in said chamber, hence, the contents of the anions in the first chamber 10a and the second chamber 10b remain unchanged.

Based on the above description, in the event that the metal ions are active metals, both the anode 102 and the cathode 103 can adopt an inert electrode; in the event that the metal ions are non-active metals, the anode 102 can adopt the inert electrode, the cathode 103 can adopt an electrode of the same material as the metal ions.

Wherein the active metals refer to metals in which the activity of the metal element is stronger than the activity of the hydrogen element, e.g. aluminum; the non-active metals refer to metals in which the activity of the metal element is weaker than the activity of the hydrogen element, e.g. copper.

Here, the anode 102 and the cathode 103 need to contact the etching liquid directly, hence, 20 the materials of the anode 102 and the cathode 103 should both have good chemical stability and electrochemical stability.

In such a case, the anode 102 adopts an inert electrode, such that chemical reaction or electrochemical reaction to the anode 102 can be effectively avoided in the environment of the etching liquid; the cathode 103 adopts an inert electrode or a non-active metal electrode, such that chemical reaction between the cathode 103 and the etching liquid can be effectively avoided.

Based on the above description, in the event that the metal ions are non-active metals, the cathode 103 can adopt an electrode of the same material as the metal ions, which may be specifically: in the event that the etching liquid only contains one kind of metal ions, the cathode 103 can adopt a metal material to which this kind of metal ion corresponds as the electrode material; in the event that the etching liquid contains multiple kinds of metal ions, the cathode 103 can adopt a metal material to which the metal ion in the multiple kinds of metal ions whose activity is weaker than hydrogen corresponds as the electrode material, and preferably a metal material to which a kind of metal ion whose activity is the weakest (the chemical stability is the strongest) corresponds as the electrode material.

Selecting the material of the electrode through the above methods not only can avoid chemical or electrochemical reaction between the electrode and the etching liquid effectively, but also is favorable for recovery of the metal.

For example, after the etching liquid etches the metal copper, many copper ions may be left in the etching liquid; here, since the activity of the copper is weaker than the activity of the hydrogen, chemical reaction will not occur between it and the etching liquid. In this way, when the cathode 103 adopts a copper electrode, it is unnecessary to consider electrode loss, moreover, the copper ions in the etching liquid will be enriched and precipitated at the surface of the cathode 103, i.e., the copper ions are precipitated at the surface of the copper electrode, thus it is favorable for recovery of the metal copper.

After the etching liquid etches the ITO, many indium ions and tin ions will be left in the etching liquid; here, since the activity of indium is weaker than the activity of hydrogen, and the activity of hydrogen is weaker than the activity of tin, the cathode 103 may preferably adopt an indium electrode. On the basis of this, since indium belongs to rare metals, which is expensive and has a very high recovery value; therefore, taking the indium electrode as the cathode 103 may enable the indium ions in the etching liquid to be precipitated at the surface of the indium electrode, which is favorable for recovery of the metal indium.

Further, the inert electrode preferably adopts a carbon electrode.

Certainly, the inert electrode may also adopt inert electrodes of other materials, e.g., a platinum electrode, which will not define specifically here.

Based on the above description, alternatively, the anode 102 and the cathode 103 may adopt a stick electrode; or the anode 102 and the cathode 103 may adopt a planar electrode. Certainly, the anode 102 and the cathode 103 may also adopt electrodes of other shapes.

In consideration of the transfer efficiency of the metal ions under the effect of electric field, the embodiments of the present disclosure preferably adopt a planar electrode as the anode 102 and the cathode 103. Compared with the stick electrode or electrodes of other shapes, the planar electrode may increase coverage area of the electric field effectively and ensure uniform stability of the electric field, thereby increasing the transfer rate of the metal ions.

Alternatively, as shown in FIG. 1, the cation exchange membrane 101, the anode 102 and the cathode 103 all can be arranged at the interior of the etching liquid storage tank 20; in such a case, a liquid inlet 201 and a liquid outlet 202 are further arranged on the etching liquid storage tank 20. Wherein the liquid inlet 201 can be arranged at the top of the second chamber 1013, the liquid outlet 202 can be arranged at the bottom of the second chamber 10b.

Based on the above structure, the ion exchange system can be formed within the etching liquid storage 20 namely. Relative to the existing etching liquid storage apparatus, the structure will not occupy too much space, it only needs to add a DC power supply at the exterior of the etching liquid storage apparatus, and connect the positive and the negative of the DC power supply with the anode 102 and the cathode 103 through leads respectively.

On the basis of this, in the embodiments of the present disclosure, it is preferable that the volume of the first chamber 10a is larger than the volume of the second chamber 10b.

In this way, when the metal ions in the etching liquid are gathered in the second chamber 10b and are enriched to some extent, it is unnecessary to replace all the etching liquid, it only needs to replace the etching liquid in the second chamber 10b. Since the volume of the second chamber 10b is relatively small, the etching liquid that needs to be replaced is also relatively little, thus not only the operation is simple, but also the cost can be reduced.

Further, in the process of transferring the metal ions into the second chamber 10b through the cation exchange membrane 101, the content of the cations with positive charges in the first chamber 10a is reduced. In order to ensure stability of the system, the water molecules in the etching liquid will generate hydrogen ions to compensate cation lass caused by transfer of the metal ions. The specific process is:

H₂O=H⁺+OH⁻;

4OH⁻−4e⁻=2H₂O+O₂,

Since the hydrogen ions are used for compensating cation loss after transfer of the metal ions, the reaction tendency of the hydrogen ions to obtain electrons so as to generate hydrogen is relatively weak, which can exist in the etching liquid system in the first chamber 10a relatively stably. In this way, the generation of the hydrogen ions can maintain acidity of the etching liquid, thereby reducing supplementary dosage of single acid; moreover, with the extension of the use time of the etching liquid, the components of the etching liquid will be relatively constant, thereby the stability of the etching process can be improved.

Alternatively, as shown in FIG. 2, the etching liquid storage apparatus may further comprise an electrodialysis means 30 located at the exterior of the etching liquid storage tank 20; the cation exchange membrane 101, the anode 102 and the cathode 103 all can be arranged at the interior of the electrodialysis means 20; wherein the top and the bottom of the first chamber 10a can be fed through with the top and the bottom of the etching liquid storage tank 20 respectively.

Based on the above structure, the electrodialysis means 30 can be arranged at the exterior of the etching liquid storage tank 20 independently, by forming an ion exchange system in the electrodialysis means 30, the metal ions in the etching liquid can be discharged. In such a case, a DC power supply can be added at the exterior of the electrodialysis means 30, and connect the positive and negative of the DC power supply with the anode 102 and the cathode 103 through leads respectively.

In this way, the etching liquid in the etching liquid storage tank 20 can be fed through with the first chamber 10a of the electrodialysis means 30; after the etching liquid enters the first chamber 10a, the metal ions enter the second chamber 10b through the cation exchange membrane 101 under the effect of electric field; therefore, when the etching liquid returns back to the etching liquid storage tank 20, redundant metal ions in the etching liquid have been discharged.

On the basis of this, the etching liquid storage apparatus may further comprise a waste liquid tank 40 located at the exterior of the electrodialysis means 30; wherein the bottom of the second chamber 10b may be fed through with the waste liquid tank 40.

In this way, since the metal ions in the electrodialysis means 30 are gathered in the second chamber 10b, the etching liquid with a high content of metal ions in the second chamber 10b can be discharged into the waste liquid tank 40 directly.

Here, a liquid inlet (not shown in the figure) may be further arranged at the top of the second chamber 10b for supplementing electrolyte in the electrodialysis means 30; wherein the electrolyte may comprise the etching liquid, but not limited to this, as long as it is a solution that can dissolve the metal ions in the etching liquid.

Based on the above, by arranging the electrodialysis means 30 at the exterior of the etching liquid storage tank 20 independently, the size of the eletrodialysis means 30 can be controlled based on actual conditions. In actual production, an electrodialysis means 30 of a relatively small volume may be arranged, so as to enable the areas of the cation exchange membrane 101, the anode 102 and the cathode 103 to be relatively small also, thus the cost can be reduced.

Further, the electrodialysis means 30 may further comprise a gas discharge system for discharging gas generated in the electrodialysis means 30. Relative to arranging an ion exchange system in the etching liquid storage tank 20 directly, it is safer to arrange the electrodialysis means 30 at the exterior of the etching liquid storage tank 20 independently.

Specifically, since the etching liquid storage tank 20 is generally in a closed state, the etching liquid therein can fill in the whole tank essentially, therefore, the gas generated in the etching liquid storage tank 20 may possibly enter the chamber of the wet etching device with the etching liquid. On the basis of this, by arranging the electrodialysis means 30 independently, the volume of the apparatus and the content of the liquid therein can be determined based on actual conditions, meanwhile, a gas discharge system can also be arranged so as to improve security of production.

In order to carry out the above solution, preferably, the anode 102 may be connected with the positive of the DC power supply, the cathode 103 may be connected with the negative of the DC power supply; wherein the power of the DC power supply is adjustable.

Specifically, the DC power supply can be initiated after the etching liquid is used for a period of time, i.e., after the concentration of the metal ions reaches to a certain extent, then combine with a concentration manager to realize real time monitoring of the concentration of the metal ions in the etching liquid. When the concentration of the metal ions is relatively high, the power of the DC power supply can be increased; when the concentration of the metal ions is relatively low, the power of the DC power supply can be decreased, or the DC power supply can be turned off temporarily, so as to keep dynamic balance of the concentration of the metal ions in the etching liquid, thereby improving stability of the wet etching process.

The embodiment of the present disclosure further provides a wet etching device comprising an etching liquid storage apparatus mentioned above.

It should be explained that the embodiments of the present disclosure only take the etching liquid storage apparatus and the wet etching device as examples to illustrate the technical solution of the present disclosure, however, the protection scope of the present disclosure is not limited to this, as long as an ion exchange system is arranged on the basis of a solution storage apparatus so as to carry out selection of ions in the solution, it will fall within the protection scope of the present disclosure.

The above is only detailed description of the present disclosure, however, the protection scope of the present disclosure is not limited to this, any changes or replacements that can be easily conceived by the skilled person familiar with the present technical field within the technical scope disclosed by the present disclosure should be covered within the protection scope of the present disclosure. Therefore, the protection scope of the present disclosure should be based on the protection scope of the claims.

1. An etching liquid storage apparatus, wherein the etching liquid storage apparatus comprises an etching liquid storage tank, an ion exchange membrane for enabling selective permeation of ions in the etching liquid, and an anode or a cathode located at both sides of the ion exchange membrane;
wherein a first chamber is formed between the ion exchange membrane and the anode, a second chamber is formed between the ion exchange membrane and the cathode.

2. The etching liquid storage apparatus according to claim 1, wherein the ion exchange membrane is a cation exchange membrane;
wherein metal ions in the etching liquid enter the second chamber from the first chamber through the cation exchange membrane under the effect of electric field between the anode and the cathode.

3. The etching liquid storage apparatus according to claim 2, wherein
both the anode and the cathode adopt an inert electrode in the event that the metal ions are active metals;
the anode adopts an inert electrode and the cathode adopts an electrode of the same material as the metal ions in the event that the metal ions are non-active metals.

4. The etching liquid storage apparatus according to claim 3, wherein the inert electrode comprises a carbon electrode.

5. The etching liquid storage apparatus according to claim 2, wherein the cation exchange membrane, the anode and the cathode are all arranged at the interior of the etching liquid storage tank;
a liquid inlet and a liquid outlet are further arranged on the etching liquid storage tank;
wherein the liquid inlet is arranged at the top of the second chamber, the liquid outlet is arranged at the bottom of the second chamber.

6. The etching liquid storage apparatus according to claim 5, wherein the volume of the first chamber is larger than the volume of the second chamber.

7. The etching liquid storage apparatus according to claim 2, wherein the etching liquid storage apparatus further comprises an electrodialysis means located at the exterior of the etching liquid storage tank;
the cation exchange membrane, the anode and the cathode are all arranged at the interior of the electrodialysis means;
wherein the top and the bottom of the first chamber are fed through with the top and the bottom of the etching liquid storage tank respectively.

8. The etching liquid storage apparatus according to claim 7, wherein the etching liquid storage apparatus further comprises a waste liquid tank located at the exterior of the electrodialysis means;
wherein the bottom of the second chamber is fed through with the waste liquid tank.

9. The etching liquid storage apparatus according to claim 1, wherein the anode and the cathode adopt a stick electrode;
or the anode and the cathode adopt a planar electrode.

10. The etching liquid storage apparatus according to claim 2, wherein the anode and the cathode adopt a stick electrode;
or the anode and the cathode adopt a planar electrode.

11. The etching liquid storage apparatus according to claim 3, wherein the anode and the cathode adopt a stick electrode;
or the anode and the cathode adopt a planar electrode.

12. The etching liquid storage apparatus according to claim 4, wherein the anode and the cathode adopt a stick electrode;
or the anode and the cathode adopt a planar electrode.

13. The etching liquid storage apparatus according to claim 5, wherein the anode and the cathode adopt a stick electrode;
or the anode and the cathode adopt a planar electrode.

14. The etching liquid storage apparatus according to claim 6, wherein the anode and the cathode adopt a stick electrode;
or the anode and the cathode adopt a planar electrode.

15. The etching liquid storage apparatus according to claim 7, wherein the anode and the cathode adopt a stick electrode;
or the anode and the cathode adopt a planar electrode.

16. The etching liquid storage apparatus according to claim 8, wherein the anode and the cathode adopt a stick electrode;
or the anode and the cathode adopt a planar electrode.

17. The etching liquid storage apparatus according to claim 1, wherein the anode is connected with the positive of a DC power supply, the cathode is connected with the negative of the DC power supply;
wherein the power of the DC power supply is adjustable.

18. The etching liquid storage apparatus according to claim 1, wherein the etching liquid storage apparatus further comprises a concentration manager connected with the etching liquid storage tank for performing real time monitoring of concentrations of respective components of the etching liquid.

19. A wet etching device, wherein the wet etching device comprises an etching liquid storage apparatus according to claim 1.
